(19) United States
(12) Patent Application Publication
(10) Pub. No.: US 2022/0254158 A1
(43) Pub. Date: Aug. 11, 2022

(54) LEARNING SITUATION ANALYSIS METHOD, ELECTRONIC DEVICE, AND STORAGE MEDIUM

(71) Applicant: Beijing Sensetime Technology Development Co., Ltd., Beijing (CN)

(72) Inventors: Heran Sun, Beijing (CN); Lei Wang, Beijing (CN); Jun Cao, Beijing (CN)

(21) Appl. No.: 17/730,800

(22) Filed: Apr. 27, 2022

Related U.S. Application Data
(63) Continuation of application No. PCT/CN2021/088690, filed on Apr. 21, 2021.

(30) Foreign Application Priority Data
Oct. 30, 2020 (CN) 202011190170.2

(51) Int. Cl. G06V 20/40; G06V 40/20; G06V 40/16

(52) U.S. Cl. CPC G06V 20/44; G06V 40/28; G06V 40/161; G06V 20/41; G06V 40/174; G06V 40/172; G06V 40/23

(57) ABSTRACT

The present disclosure relates to a learning situation analysis method and apparatus, an electronic device, a storage medium and a computer program. An example method includes: acquiring in-class video data to be analyzed; obtaining an in-class action event by performing a student detection on the in-class video data, wherein the in-class action event reflects an action of a student in class; and determining a learning situation analysis result corresponding to the in-class video data based on the in-class action event, wherein the learning situation analysis result reflects a learning situation of the student in class.

### CROSS-REFERENCE TO RELATED APPLICATION

This application is a continuation application of the PCT International Application No. PCT/CN2021/088690 filed on Apr. 21, 2021, which claims the benefit of foreign priority of Chinese patent application No. 202011190170.2 filed on Oct. 30, 2020. All of above-mentioned applications are incorporated herein by reference in their entirety.

### TECHNICAL FIELD

The present disclosure relates to the technical field of computers, and particularly to a learning situation analysis method and apparatus, an electronic device, a storage medium and a computer program.

### BACKGROUND

The class, as a main place for teachers to impart knowledge and students to learn knowledge, is a space for communication and interaction between teachers and students, and a channel for teachers to guide students to develop and explore the knowledge. To facilitate the teachers or teaching institutions to know the learning status of the students in time and to optimize the in-class teaching effect, it is necessary to effectively analyze learning situations of the students in class.

### SUMMARY

The present disclosure provides technical solutions of a learning situation analysis method and apparatus, an electronic device, a storage medium and a computer program.

According to one aspect of the present disclosure, there is provided a learning situation analysis method, comprising: acquiring in-class video data to be analyzed; obtaining an in-class action event by performing a student detection on the in-class video data, wherein the in-class action event reflects an action of a student in class; and determining a learning situation analysis result corresponding to the in-class video data based on the in-class action event, wherein the learning situation analysis result reflects a learning situation of the student in class.

In one possible implementation, the method further comprising: displaying, in response to a replay or a real-time play of the in-class video data, the learning situation analysis result through a display interface for playing the in-class video data.

In one possible implementation, wherein obtaining an in-class action event by performing a student detection on the in-class video data includes: performing the student detection respectively on a plurality of frames of image included in the in-class video data to obtain at least one detection box corresponding to each frame of image in the plurality of frames of image, wherein the detection box identifies a detection result of the student detection in the image; and taking identical detection boxes included in the plurality of frames of image as a target detection box, and tracking the target detection box in the in-class video data to obtain the in-class action event of a student corresponding to the target detection box.

In a possible implementation, the student detection includes at least one of face detection or human-body detection; in a case where the student detection includes the face detection, the student detection is performed respectively on a plurality of frames of image included in the in-class video data to obtain at least one face box corresponding to each frame of image in the plurality of frames of image; and in a case where the student detection includes the human-body detection, the student detection is performed respectively on a plurality of frames of image included in the in-class video data to obtain at least one human-body box corresponding to each frame of image in the plurality of frames of image.

In a possible implementation, the in-class action event includes at least one of a concentration event, a look-around event, a lowering-head event, a hand-raising event, or a stand-up event.

In one possible implementation, wherein the student detection includes the face detection, and the detection box includes the face box; said taking identical detection boxes included in the plurality of frames of image as a target detection box and tracking the target detection box in the in-class video data to obtain the in-class action event of a student corresponding to the target detection box includes: taking identical face boxes included in the plurality of frame of images as a target detection box, and tracking the target detection box in the in-class video data; in a case where a face angle in a horizontal direction of a face in the target detection box is detected in the tracked plurality of frames of image as being less than a first angle threshold, determining that a concentration event occurs for the student corresponding to the target detection box; and/or, in a case where a face angle in a horizontal direction of a face in the target detection box is detected in the tracked plurality of frames of image as being greater than or equal to a second angle threshold, determining that a look-around event occurs for the student corresponding to the target detection box, wherein the first angle threshold is less than or equal to the second angle threshold; and/or, in a case where a face angle in a vertical direction of a face in the target detection box is detected in the tracked plurality of frames of image as being greater than or equal to a third angle threshold, determining that a lowering-head event occurs for the student corresponding to the target detection box.

In a possible implementation, the detection box includes the human-body box; and said taking identical detection boxes included in the plurality of frames of image as a target detection box and tracking the target detection box in the in-class video data to obtain the in-class action event of a student corresponding to the target detection box includes: taking identical human-body boxes included in a plurality of frames of image as the target detection box, and tracking the target detection box in the in-class video data; and in a case where the human-body in the target detection box is detected in the tracked plurality of frames of image as having a hand-raising action, determining that a hand-raising event occurs for the student corresponding to the target detection box; and/or, in a case where the human-body in the target detection box is detected in the tracked in-class video data as having a stand-up action, a standing action, and a sit-down action sequentially, determining that a stand-up event occurs for the student corresponding to the target detection box.

In a possible implementation, determining that the stand-up event occurs for the student corresponding to the target detection box in a case where the human-body in the target detection box is detected in the tracked in-class video data as having a stand-up action, a standing action, and a sit-down action sequentially includes: determining that the stand-up event occurs for the student corresponding to the target detection box upon the following case, where a central point of the target detection box is detected in the tracked in-class video data within a target period of time greater than a duration threshold as having a horizontal offset amplitude less than a first horizontal offset threshold and a vertical offset amplitude less than a first vertical offset threshold, for a first frame of image in the target period of time, a vertical offset amplitude of the central point with respect to images before the target period of time is greater than a second vertical offset threshold, and for a last frame of image in the target period of time, a vertical offset amplitude of the central point with respect to images after the target period of time is greater than a third vertical offset threshold.

In a possible implementation, the method further comprising: merging in-class action events which are the same and have occurred multiple times consecutively in a case where a time interval between multiple consecutive occurrences of the in-class action events of the student corresponding to the target detection box is less than a first time interval threshold.

In a possible implementation, the learning situation analysis result includes at least one of: a number of students corresponding to different in-class action events, a ratio thereof, a duration thereof, an in-class concentration degree, an in-class interaction degree, or an in-class delight degree.

In a possible implementation, the method further comprising at least one of: performing a facial expression recognition on a face image in the target detection box to obtain a facial expression category of the student corresponding to the target detection box, and displaying the facial expression category through an associated area of the face image on a display interface for playing the in-class video data; or performing a face recognition on the face image in the target detection box based on a preset face database to obtain identity information of the student corresponding to the target detection box, and displaying the identity information through the associated area of the face image on the display interface for playing the in-class video data.

In a possible implementation, the method further comprising: displaying character images of the student corresponding to the target detection box through the display interface for playing the in-class video data, wherein a display sequence of the character images is related to times at which the in-class action events of the student corresponding to the target detection box occur; and/or determining a number of attendance corresponding to the in-class video data based on the identity information of the students corresponding to different target detection boxes in the in-class video data, and displaying the number of attendance through the display interface for playing the in-class video data.

According to one aspect of the present disclosure, there is provided a learning situation analysis apparatus, comprising: a video acquisition module to acquire in-class video data to be analyzed; an in-class action event detecting module to obtain an in-class action event by performing a student detection on the in-class video data, wherein the in-class action event reflects an action of a student in class; and a learning situation analyzing module to determine a learning situation analysis result corresponding to the in-class video data based on the in-class action event, wherein the learning situation analysis result reflects a learning situation of the student in class.

According to one aspect of the present disclosure, there is provided an electronic device, comprising: a processor; and a memory configured to store processor executable instructions, wherein the processor is configured to invoke the instructions stored in the memory to execute the above method.

According to one aspect of the present disclosure, there is provide a computer readable storage medium having computer program instructions stored thereon, wherein the computer program instructions, when executed by a processor, implement the above method.

According to one aspect of the present disclosure, there is provide a computer program, comprising computer readable codes, wherein when the computer codes are running on an electronic device, a processor in the electronic device executes the above method.

In embodiments of the present disclosure, the in-class video data to be analyzed is acquired; since the in-class video data contains video data of students during the class, the in-class action event reflecting an action of the student in class may be obtained by performing a student detection on the in-class video data, and then a learning situation of the student in class may be analyzed effectively based on the action of the student in class to obtain a learning situation analysis result.

It should be understood that the above general descriptions and the following detailed descriptions are only exemplary and illustrative, and do not limit the present disclosure. Other features and aspects of the present disclosure will become apparent from the following detailed descriptions of exemplary embodiments with reference to the accompanying drawings.

### BRIEF DESCRIPTION OF THE DRAWINGS

The drawings described here are incorporated into the specification and constitute a part of the specification. The drawings illustrate embodiments in conformity with the present disclosure and are used to explain the technical solutions of the present disclosure together with the specification.

FIG. 1 illustrates a flow chart of a learning situation analysis method according to an embodiment of the present disclosure;

FIG. 2 illustrates a schematic diagram of a display interface before the beginning of class according to an embodiment of the present disclosure;

FIG. 3 illustrates a schematic diagram of the display interface after the beginning of class according to an embodiment of the present disclosure;

FIG. 4 illustrates a block diagram of a learning situation analysis apparatus according to an embodiment of the present disclosure;

FIG. 5 illustrates a block diagram of an electronic device according to an embodiment of the present disclosure; and

FIG. 6 illustrates a block diagram of the electronic device according to an embodiment of the present disclosure.

### DETAILED DESCRIPTION

Various exemplary embodiments, features and aspects of the present disclosure are described in detail below with reference to the accompanying drawings. Reference numerals in the drawings indicate elements with same or similar functions. Although various aspects of the embodiments are illustrated in the drawings, the drawings are not necessarily drawn to scale unless otherwise specified.

The term “exemplary” herein means “using as an example and an embodiment or being illustrative”. Any embodiment described herein as “exemplary” should not be construed as being superior or better than other embodiments.

Terms “and/or” used herein is only an association relationship describing the associated objects, which means that there may be three relationships, for example, A and/or B may mean three situations: A exists alone, both A and B exist, and B exists alone. Furthermore, the item “at least one of” herein means any one of a plurality of or any combinations of at least two of a plurality of, for example, “including at least one of A, B or C” may represent including any one or more elements selected from a set consisting of A, B and C.

Furthermore, for better describing the present disclosure, numerous specific details are illustrated in the following detailed description. Those skilled in the art should understand that the present disclosure may be implemented without certain specific details. In some examples, methods, means, elements and circuits that are well known to those skilled in the art are not described in detail in order to highlight the main idea of the present disclosure.

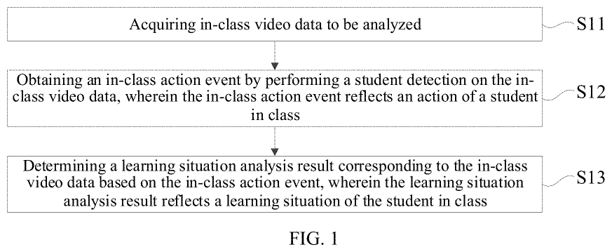

FIG. 1 illustrates a flow chart of a learning situation analysis method according to an embodiment of the present disclosure. The method may be executed by an electronic device such as a terminal device or a server; the terminal device may be a user equipment (UE), a mobile device, a user terminal, a cellular phone, or a cordless telephone, a personal digital assistant (PDA), a handheld device, a computing device, a vehicle-mounted device, a wearable device, etc. The method may be implemented by a processor invoking computer readable instructions stored in a memory. Or the method may be executed by the server. As shown in FIG. 1, the method may include:

In step S11, acquiring in-class video data to be analyzed.

The in-class video data to be analyzed refers to video data captured of the student during class, for example, it may be the video data including teachers, students and an in-class environment during class. It should be noted that, the technical solutions provided by the present disclosure are also suitable for the status analysis of participants in a conference scene, and the status analysis of participants during a video/slide presentation. The application field is not limited here and may include but is not limited to the above listed situations. In the present disclosure, a teaching scene is taken as an example to describe the technical solutions provided by the present disclosure.

In an embodiment of the present disclosure, the in-class video data to be analyzed may be real-time video streaming data. For example, an image acquisition device (such as a camera) is installed at a preset spatial position in class, and an electronic device executing the learning situation analysis is connected with the image acquisition device to acquire the in-class video streaming data captured by the image acquisition device in real time. The preset spatial position may include one or more position areas. For example, in a case where the preset spatial position includes one position area, the image acquisition device may be a 360-degree panoramic camera for capturing video images including participants (not limited to the students and the teachers) in class. Further, for example, in a case where the preset spatial position includes a plurality of position areas, the image acquisition device may include a plurality of cameras with the same or different configurations, and acquisition ranges of different cameras may overlap partially or may not overlap at all. In this way, the video images of the participants in class may be obtained based on the video data acquired by the different cameras.

In an embodiment of the present disclosure, the in-class video data to be analyzed may be a pre-recorded video file. For example, the image acquisition device (such as the camera) is installed at the preset spatial position in class, the image acquisition device records the in-class video data, and when it is necessary to perform the learning situation analysis, the pre-recorded in-class video data may be imported into the electronic device executing the learning situation analysis.

In an embodiment of the present disclosure, an acquisition approach for the in-class video data to be analyzed may be configured in a configuration interface of the electronic device executing the learning situation analysis. For example, the acquisition approach for the in-class video data to be analyzed that may be configured in a configuration page includes real-time video stream or video files. Besides two means of the real-time video stream and the video files as mentioned above, the acquisition approach for the in-class video data to be analyzed may also be configured as other approaches according to the actual situation, which is not specifically limited in the present disclosure.

In step S12, obtaining an in-class action event by performing a student detection on the in-class video data, wherein the in-class action event reflects an action of a student in class.

Since the in-class video data to be analyzed contains the video data of the student during class, the in-class action event reflecting the action of the student in class may be obtained by performing the student detection on the in-class video data.

In step S13, determining a learning situation analysis result corresponding to the in-class video data based on the in-class action event, wherein the learning situation analysis result reflects a learning situation of the student in class.

Since the in-class action event can reflect the action of the student in class, and the action of the student in class may reflect a learning status of the student, the learning situation of the student in class may be analyzed effectively based on the in-class action event to obtain a learning situation analysis result.

According to an embodiment of the present disclosure, the in-class video data to be analyzed is acquired. Since the in-class video data contains the video data of the student during class, the in-class action event reflecting the action of the student in class may be obtained by performing the student detection on the in-class video data, and then the learning situation of the student in class may be analyzed effectively based on the action of the student in class to obtain the learning situation analysis result.

In a possible implementation, the method further includes: displaying, in response to a replay or a real-time play of the in-class video data, the learning situation analysis result through a display interface for playing the in-class video data.

The learning situation analysis result is displayed through the display interface for a replay or a real-time play of the in-class video data; this facilitates to observe and get to know the learning situation of the student in class intuitively. It also means that the learning situation analysis result may be displayed synchronously during a play of the in-class video data to assist a user checking the in-class video data to get to know the learning situations of different students in class and/or an overall learning situation of the students more intuitively.

Considering that the learning situation analysis may consume a great amount of computing resource, even if the in-class video data to be analyzed includes the video data before the beginning of class, the video data before the beginning of class will not be subjected to the learning situation analysis, thereby improving the validity of the learning situation analysis result with saved computing resource.

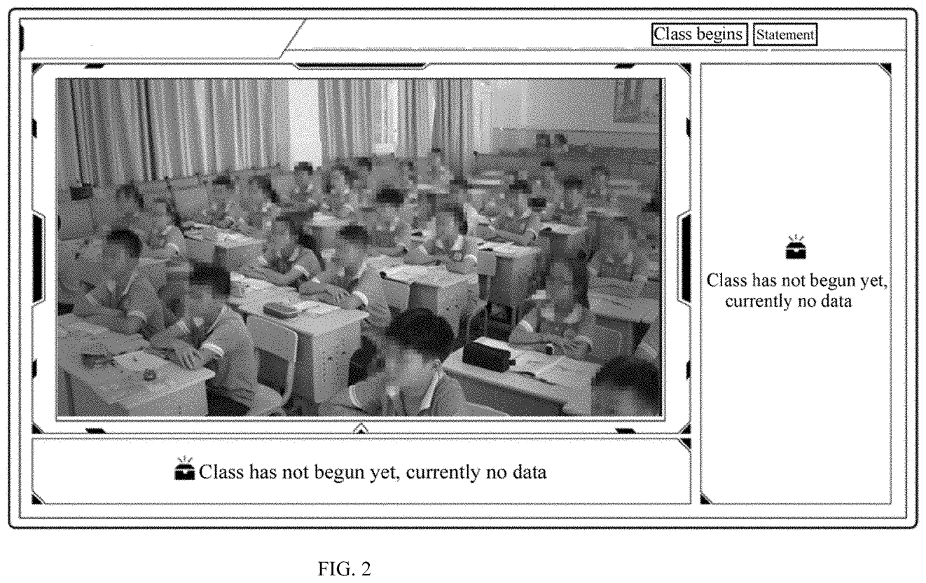

FIG. 2 illustrates a schematic diagram of a display interface before the beginning of class according to an embodiment of the present disclosure. As shown in FIG. 2, in an electronic device executing the learning situation analysis, in response to a replay or a real-time play of the in-class video data, the video data before the beginning of class included in the in-class video data may be played through the display interface for playing the in-class video data. Because the electronic device does not perform the learning situation analysis on the video data before the beginning of class, when playing the video data before the beginning of class, no corresponding learning situation analysis result is displayed.

The display interface for playing the in-class video data may include a control of “beginning the class”, and the learning situation analysis on the video data after the beginning of class included in the in-class video data is enabled by triggering the control of “beginning the class” on the display interface. Of course, about whether to start or finish the learning situation analysis, besides the manual trigger by the user, a class beginning time and a class dismissing time can be preset to achieve the learning situation analysis for a fixed period of time automatically. The implementation for triggering and closing the learning situation analysis is not limited herein and may include but is not limited to the above listed situations.

In a case where the video preview means for the in-class video data to be analyzed is a video file, a class beginning time corresponding to the in-class video data included in the video file may be determined by preprocessing the video file, then the learning situation analysis on the video data after the beginning of class included in the in-class video data is enabled when the class beginning time is arrived during the play of the in-class video data.

In a possible implementation, obtaining an in-class action event by performing a student detection on the in-class video data includes: performing the student detection respectively on a plurality of frames of image included in the in-class video data to obtain at least one detection box corresponding to each frame of image in the plurality of frames of image. The detection box identifies at least one detection result of the student detection in the image. Identical detection boxes included in a plurality of frames of image are taken as a target detection box, and the target detection box in the in-class video data is tracked to obtain the in-class action event of the student corresponding to the target detection box.

Because the in-class video data includes the video data of the student during class, for the video data after the beginning of class, at least one detection box corresponding to each frame of image in the plurality of frames of image may be obtained by performing the student detection respectively on the plurality of frames of image included in the video data. In a case where identical detection boxes are included a plurality of frames of image, the identical detection boxes included in the plurality of frames of image may be considered as corresponding to the same student. Therefore, the identical detection boxes included in the plurality of frames of image may be taken as the target detection box, and the target detection box in the in-class video data is tracked to enable a tracking on the student corresponding to the target detection box; then the in-class action event of the student corresponding to the target detection box may be obtained.

In an embodiment of the present disclosure, a plurality of frames of image may be a plurality of frames of image in the in-class video data which are adjacent or not adjacent in time sequence. For example, a plurality of frames of image include a video clip (i.e., including a plurality of frames of adjacent images) in the in-class video data, a plurality of non-adjacent video clips, and a plurality of frames of non-adjacent images sampled from the in-class video data, etc. The present disclosure does not limit a specific form of the plurality of frames of image.

In a possible implementation, the student detection includes at least one of face detection or human-body detection. In a case where the student detection includes the face detection, the student detection is performed respectively on a plurality of frames of image included in the in-class video data to obtain at least one face box corresponding to each frame of image in the plurality of frames of image; and in a case where the student detection includes the human-body detection, the student detection is performed respectively on a plurality of frames of image included in the in-class video data to obtain at least one human-body box corresponding to each frame of image in the plurality of frames of image.

Since the student detection includes at least one of the face detection or the human-body detection, the detection box obtained by performing the student detection on the in-class video data may include at least one of the face box or the human-body box. The target detection box corresponding to the same student may include one detection box, such as the face box or the human-body box corresponding to the student, or may include a combination of a plurality of detection boxes, such as a combination of the face box and the human-body box corresponding to the student. The present disclosure does not limit a specific form of the target detection box.

In a possible implementation, the in-class action event includes at least one of a concentration event, a look-around event, a lowering-head event, a hand-raising event, or a stand-up event.

By tracking and detecting at least one of the concentration event, the look-around event, the lowering-head event, the hand-raising event, or the stand-up event of the student in class, it can be determined effectively whether the student is interested in the teaching content in class, and the learning situation analysis result reflecting the learning situation of the student in class then may be obtained.

In a possible implementation, the method further includes: merging in-class action events which are the same and have occurred multiple times consecutively in a case where a time interval between multiple consecutive occurrences of the in-class action events of the student corresponding to the target detection box is less than a first time interval threshold.

The time interval between the multiple consecutive occurrences of the same in-class action events is less than the first time interval threshold, which may refer to that the time interval between two adjacent in-class action events which are the same is less than the first time interval threshold, or that among multiple consecutive occurrences of the in-class action events, the time interval between any two adjacent in-class action events is less than the first time interval threshold, or that the time interval between a first occurrence and a last occurrence of the in-class action event is less than the first time interval threshold.

There could be a situation that some frames may fail to be detected or some frames may have large detection errors during the detection, so in order to improve detection accuracy, it may be determined that a detection failure or a large detection error may have occurred in a time interval if the time interval between the multiple consecutive occurrences of the same in-class action event of the student corresponding to the target detection box is less than the first time interval threshold. Therefore, the same in-class action events occurred for multiple times consecutively before and after the time interval may be merged. A specific value of the first time interval threshold may be determined according to the actual situation, which is not specifically limited in the present disclosure.

In a possible implementation, the detection box includes the face box; and taking identical detection boxes included in the plurality of frames of image as a target detection box and tracking the target detection box in the in-class video data to obtain the in-class action event of a student corresponding to the target detection box includes: taking identical face boxes included in the plurality of frame of images as a target detection box, and tracking the target detection box in the in-class video data; in a case where a face angle in a horizontal direction of a face in the target detection box is detected in the tracked plurality of frames of image as being less than a first angle threshold, determining that a concentration event occurs for the student corresponding to the target detection box.

Therein, the horizontal direction may be a corresponding direction when the face moves side to side, and the face angle in the horizontal direction of the face in the target detection box being less than the first angle threshold may reflect that the student corresponding to the target detection box looks ahead at the very moment. For example, the student is looking at a blackboard on the podium or a teacher on the platform at the very moment. A specific value of the first angle threshold may be determined according to the actual situation, which is not specifically limited in the present disclosure.

The time interval between a first frame and a last frame in a plurality of frames of image may be greater than a second time interval threshold; that is, the face angle in the horizontal direction of the face in the target detection box is detected to be less than the first angle threshold in some or all images in a video clip greater than the second time interval threshold in the in-class video data, and then it may be determined that a concentration event occurs for the student corresponding to the target detection box in the video clip. A specific value of the second time interval threshold may be determined according to the actual situation, which is not specifically limited in the present disclosure.

By tracking and detecting in a plurality of frames of image whether the face angle in the horizontal direction of the face in the target detection box is less than the first angle threshold, it can be determined quickly and effectively whether the concentration event occurs for the face corresponding to the target detection box.

In order to improve the detection accuracy, for the student corresponding to the target detection box, in a case where the time interval between multiple consecutive occurrences of concentration events is less than the first time interval threshold, it may be determined that a detection failure or a large detection error may have occurred in the time interval. Therefore, the multiple consecutive concentration events may be merged into one concentration event. A specific value of the first time interval threshold may be determined according to the actual situation, which is not specifically limited in the present disclosure.

In a possible implementation, the method further includes: in a case where a face angle in a horizontal direction of a face in the target detection box is detected in the tracked plurality of frames of image as being greater than or equal to a second angle threshold, determining that a look-around event occurs for the student corresponding to the target detection box, wherein the first angle threshold is less than or equal to the second angle threshold.

Therein, the face angle in the horizontal direction of the face in the target detection box being greater than or equal to the second angle threshold may reflect that the student corresponding to the target detection box is not looking ahead but is looking around at the very moment. For example, the face angle in the horizontal direction of the face in the target detection box being greater than or equal to a positive second angle threshold may reflect that the student corresponding to the target detection box is looking with his/her head turned to the left; and the face angle in the horizontal direction of the face in the target detection box being greater than or equal to a negative second angle threshold may reflect that the student corresponding to the target detection box is looking with his/her head turned to the right.

Because a swing amplitude of the face when the student looks around is greater than the swing amplitude of the face when the student looks ahead, the first angle threshold is less than or equal to the second angle threshold. However, a specific value of the second angle threshold may be determined according to the actual situation, which is not specifically limited in the present disclosure.

The time interval between the first frame and the last frame in a plurality of frames of image may be greater than a third time interval threshold; that is, the face angle in the horizontal direction of the face in the target detection box is detected to be greater than or equal to the second angle threshold in some or all images of the video clip greater than the third time interval threshold in the in-class video data, and then it may be determined that a look-around event occurs for the student corresponding to the target detection box in the video clip. A specific value of the third time interval threshold may be determined according to the actual situation, which is not specifically limited in the present disclosure.

By tracking and detecting in a plurality of frames of image whether the face angle in the horizontal direction of the face in the target detection box is greater than or equal to the second angle threshold, it may be determined quickly and effectively whether the look-around event occurs for the face corresponding to the target detection box.

In order to improve the detection accuracy, for the student corresponding to the target detection box, in a case where the time interval between multiple consecutive look-around events is less than the first time interval threshold, it may be determined that a detection failure or a large detection error may have occurred in the time interval. Therefore, the multiple consecutive look-around events may be merged into one look-around event.

In a possible implementation, the method further includes: in a case where a face angle in a vertical direction of a face in the target detection box is detected in the tracked plurality of frames of image as being greater than or equal to a third angle threshold, determining that a lowering-head event occurs for the student corresponding to the target detection box.

Therein, the vertical direction may be a corresponding direction when the face swings up and down. The face angle in the vertical direction of the face in the target detection box being greater than or equal to the third angle threshold may reflect that the student corresponding to the target detection box is in a lowering-head state at the very moment. A specific value of the third angle threshold may be determined according to the actual situation, which is not specifically limited in the present disclosure.

The time interval between the first frame and the last frame in a plurality of frames of image may be greater than a fourth time interval threshold; that is, the face angle in the vertical direction of the face in the target detection box is detected to be greater than or equal to the third angle threshold in some or all images in a video clip greater than the fourth time interval threshold in the in-class video data, and then it may be determined that a lowering-head event occurs for the student corresponding to the target detection box in the video clip. A specific value of the fourth time interval threshold may be determined according to the actual situation, which is not specifically limited in the present disclosure.

By tracking and detecting in a plurality of frames of image whether the face angle in the vertical direction of the face in the target detection box is greater than or equal to the third angle threshold, it may be determined quickly and effectively whether the lowering-head event occurs for the face corresponding to the target detection box.

In order to improve the detection accuracy, for the student corresponding to the target detection box, in a case where the time interval between multiple consecutive lowering-head events is less than the first time interval threshold, it may be determined that a detection failure or a large detection error may have occurred in the time interval. Therefore, the two adjacent lowering-head events may be merged into one lowering-head event.

In a possible implementation, the detection box includes the human-body box; and taking identical detection boxes included in the plurality of frames of image as a target detection box and tracking the target detection box in the in-class video data to obtain the in-class action event of a student corresponding to the target detection box includes: taking identical human-body boxes included in a plurality of frames of image as the target detection box, and tracking the target detection box in the in-class video data; and in a case where the human-body in the target detection box is detected in the tracked plurality of frames of image as having a hand-raising action, determining that a hand-raising event occurs for the student corresponding to the target detection box.

The time interval between the first frame and the last frame in a plurality of frames of image may be greater than a fifth time interval threshold; that is, the human-body in the target detection box is detected to have the hand-raising action in some or all images in the video clip greater than the fifth time interval threshold in the in-class video data, and then it may be determined that a hand-raising event occurs for the student corresponding to the target detection box in the video clip. A specific value of the fifth time interval threshold may be determined according to the actual situation, which is not specifically limited in the present disclosure.

By tracking and detecting in a plurality of frames of image whether the hand-raising action occurs for the human-body in the target detection box, it can be determined quickly and effectively whether the hand-raising event occurs for the human-body corresponding to the target detection box.

In a possible implementation, whether the human-body in the target detection box has the hand-raising action is detected in the tracked plurality of frames of image through a hand-raising detecting model.

Therein, the hand-raising detecting model may be obtained by pre-training. A training process of the hand-raising detecting model may adopt a corresponding network training method as needed, which is not specifically limited in the present disclosure.

In a possible implementation, a key point detection is performed on the human-body in the target detection box to obtain an angle between an upper arm and a forearm of the human-body and/or an angle between a shoulder and an upper arm of the human-body; and in a case where it is detected in the tracked plurality of frames of image that the angle between the upper arm and the forearm of the human-body is less than or equal to the fourth angle threshold, and the angle between the shoulder and the upper arm of the human-body is less than or equal to the fifth angle threshold, it is determined that the hand-raising action occurs for the human-body in the target detection box.

The angle between the upper arm and the forearm of the human-body or the angle between the shoulder and the upper arm of the human-body may reflect an arm action of the human-body at the very moment. The angle between the upper arm and the forearm of the human-body being less than or equal to the fourth angle threshold may reflect that the forearm of the human-body has an action of bending towards the upper arm at the very moment, that is, the hand-raising action occurs for the human-body. Or the angle between the shoulder and the upper arm of the human-body being less than or equal to the fifth angle threshold may reflect that the upper arm of the human-body has an action of rising to the head at the very moment, that is, the hand-raising action occurs for the human-body.

Therefore, by tracking and detecting in a plurality of frames of image whether the angle between the upper arm and the forearm of the human-body in the target detection box is less than or equal to the fourth angle threshold or whether the angle between the shoulder and the upper arm of the human-body is less than or equal to the fifth angle threshold, it may be determined quickly and effectively whether the hand-raising event occurs for the human-body corresponding to the target detection box. Specific values of the fourth angle threshold and fifth angle threshold may be determined according to the actual situation, which are not specifically limited in the present disclosure.

In order to improve the detection accuracy, for the student corresponding to the target detection box, in a case where the time interval between multiple consecutive hand-raising events is less than the first time interval threshold, it may be determined that a detection failure or a large detection error may have occurred in the time interval. Therefore, the adjacent two hand-raising events may be merged into one hand-raising event.

In a possible implementation, the method further includes: in a case where the human-body in the target detection box is detected in the tracked in-class video data as having a stand-up action, a standing action, and a sit-down action sequentially, determining that a stand-up event occurs for the student corresponding to the target detection box.

In order to distinguish an event that the student is always in standing and an event that the student sits down, stands up, and then walks out of the classroom, a valid stand-up event is set as including three phases, i.e., the stand-up action, the standing action, and the sit-down action. Therefore, in a case where the human-body in the target detection box is detected in the tracked in-class video data as sequentially having the stand-up action, the standing action, and the sit-down action, it may be determined that a stand-up event occurs for the student corresponding to the target detection box.

In a possible implementation, determining that the stand-up event occurs for the student corresponding to the target detection box in a case where the human-body in the target detection box is detected in the tracked in-class video data as having a stand-up action, a standing action, and a sit-down action sequentially includes: determining that the stand-up event occurs for the student corresponding to the target detection box upon the following case, where a central point of the target detection box is detected in the tracked in-class video data within a target period of time greater than a duration threshold as having a horizontal offset amplitude less than a first horizontal offset threshold and a vertical offset amplitude less than a first vertical offset threshold, for a first frame of image in the target period of time, a vertical offset amplitude of the central point with respect to images before the target period of time is greater than a second vertical offset threshold; and for a last frame of image in the target period of time, a vertical offset amplitude of the central point with respect to images after the target period of time is greater than a third vertical offset threshold.

Therein, the horizontal offset amplitude of the center point of the target detection box may reflect whether a walking action occurs for the student corresponding to the target detection box; and the vertical offset amplitude of the center point of the target detection box may reflect whether the standing action occurs for the student corresponding to the target detection box.

With respect to images before the target period of time, the vertical offset amplitude of the center point of the target detection box in the first frame of image in the in-class video data within the target period of time greater than the duration threshold being greater than the second vertical offset threshold may reflect that the stand-up action occurs for the student corresponding to the target detection box.

The center point of the target detection box tracked and detected in the target period of time as having a horizontal offset amplitude less than the first horizontal offset threshold and having a vertical offset amplitude less than the first vertical offset threshold may reflect that a constant standing action occurs for the student corresponding to the target detection box in the target period of time.

With respect to images after the target period of time, the vertical offset amplitude of the center point of the target detection box in the last frame of image within the target period of time being greater than the third vertical offset threshold may reflect that the sit-down action occurs for the student corresponding to the target detection box.

Then, it may be determined that the student corresponding to the target detection box sequentially has three phases, i.e., the stand-up action, the standing action, and the sit-down action, that is, a stand-up event occurs for the student corresponding to the target detection box.

Therein, specific values of the first horizontal offset threshold, the first vertical offset threshold, the second vertical offset threshold and the third vertical offset threshold may be determined according to the actual situation, which are not specifically limited in the present disclosure.

In the embodiments of the present disclosure, “the first”, “the second”, and “the N^{th}” (N is a positive integer) are merely used to distinguish different substances and should not be understood as limiting the protection scope of the present disclosure, for example, should not be understood as limiting the sequence or size of different substances.

In a possible implementation, content to be displayed through a page for playing the in-class video data may be configured in a configuration page of an electronic device executing the learning situation analysis. For example, the content to be displayed includes at least one of: the face box, the human-body box, a face information box, the student ID, names of students, the hand-raising event, the stand-up event, the concentration event, the lowering-head event, the look-around event, etc.

In a possible implementation, the method further includes: displaying at least one target detection box through the display interface for playing the in-class video data, wherein the target detection box includes the face box and/or the human-body box of the student corresponding to the target detection box.

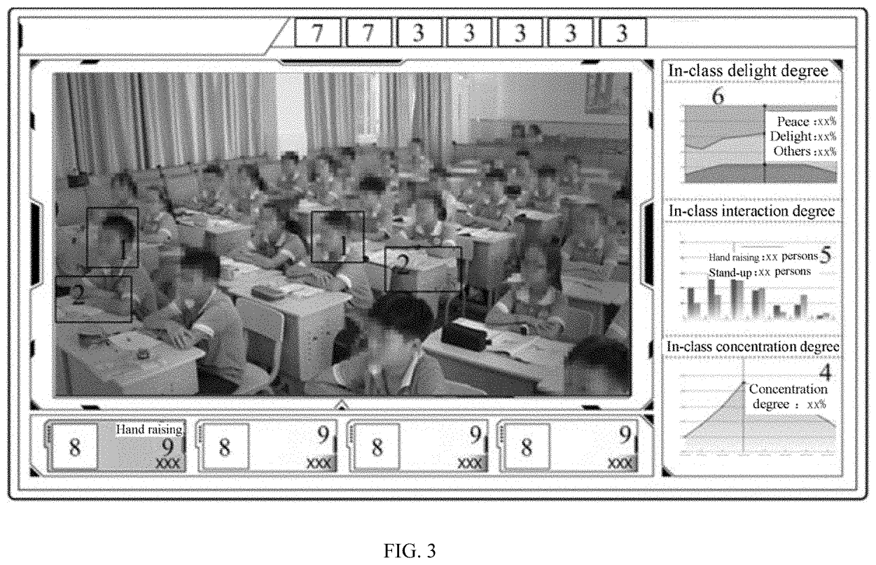

FIG. 3 illustrates a schematic diagram of a display interface after the beginning of class according to an embodiment of the present disclosure. As shown in FIG. 3, at least one face box and/or at least one human-body box corresponding to a current playing moment is displayed through the display interface for playing the in-class video data. The face box includes a face image, and the human-body box includes a human-body image.

In a possible implementation, the method further includes: performing a face recognition on the face image in the target detection box based on a preset face database to obtain identity information of the student corresponding to the target detection box, and displaying the identity information of the student corresponding to the target detection box through an associated area of the face image on the display interface for playing the in-class video data.

Therein, the associated area may be an area surrounding the face image, for example, the associated area is an area with a distance to the face box where the face image is located within a preset distance range. A specific value of the preset distance may be determined according to the actual situation, which is not specifically limited in the present disclosure.

Still referring to FIG. 3 as an example, as shown in FIG. 3, the identity information of the student corresponding to a face box 1 is displayed in an associated area 2 of the face image in the face box 1.

The preset face database stores the face images of registered students corresponding to the in-class video data to be analyzed, and the identity information corresponding to the face images. The identity information may include the student ID (the unique identifier of the student) and a name of the student. The registered students are students required to attend the class.

Sources of the preset face database may be configured in the configuration page of the electronic device executing the learning situation analysis. The sources of the preset face database may be released by a cloud (for example, a server) where the preset face database is stored, or may also be created locally (for example, the preset face database is imported into the electronic device executing the learning situation analysis)

When the learning situation analysis is performed on the in-class video data, the face recognition may be performed on the face image in the target detection box based on the preset face database to obtain the identity information of the student corresponding to the target detection box.

The face recognitions are performed on all image frames in the in-class video data, thereby accurately obtaining the identity information of the student corresponding to the target detection box in the image frames. Furthermore, in order to improve the recognition efficiency, the face recognition may also be performed on the images for a preset time interval in the in-class video data; for example, the face recognition is executed every 10 seconds. A specific method of the face recognition may be determined according to the actual situation, which is not specifically limited in the present disclosure.

In a possible implementation, the method further includes: performing a facial expression recognition on a face image in the target detection box to obtain a facial expression category of the student corresponding to the target detection box, and displaying the facial expression category of the student corresponding to the target detection box through an associated area of the face image on a display interface for playing the in-class video data.

Still referring to FIG. 3 as an example, as shown in FIG. 3, the facial expression category of the student corresponding to the face box 1 is displayed in the associated area 2 of the face image in the face box 1.

The facial expression category may include peace and delight. The facial expression category of the student corresponding to the target detection box may be determined as peace, delight, or others by performing the facial expression recognition on the face image in the target detection box.

In a possible implementation, in a case where the facial expression category of the student corresponding to the target detection box is delight, a smile value of the student corresponding to the target detection box is determined, and the smile value of the student corresponding to the target detection box is displayed through the associated area of the face image on the display interface for playing the in-class video data.

Still referring to FIG. 3 as an example, as shown in FIG. 3, in a case where the facial expression category of the student corresponding to the face box 1 is delight, the smile value of the student corresponding to the face box 1 is displayed in the associated area 2 of the face image in the face box 1.

A mood state of the student in class may be quickly known by recognizing and displaying the corresponding facial expression category of the student.

In a possible implementation, the learning situation analysis result includes at least one of: a number of students, a ratio and a duration corresponding to different in-class action events, an in-class concentration degree, an in-class interaction degree, or an in-class delight degree.

In a possible implementation, numbers of students corresponding to different in-class action events are determined based on the in-class action events occurring in different target detection boxes, and the numbers of the students corresponding to different in-class action events are displayed through a display area for the number of persons of events on the display interface for playing the in-class video data.

The display area for the number of persons of events may be determined according to the actual situation, for example, may be an upper area that does not cover a video footage on the display interface for playing the in-class video data, which is not specifically limited by the present invention.

The number of students corresponding to the concentration event, the number of students corresponding to the look-around event, the number of students corresponding to the lowering-head event, the number of students corresponding to the hand-raising event, and the number of students corresponding to the stand-up event are determined based on the in-class action events occurred in different target detection boxes, and the number of students corresponding to the concentration event, the number of students corresponding to the look-around event, the number of students corresponding to the lowering-head event, the number of students corresponding to the hand-raising event, and the number of students corresponding to the stand-up event are displayed through the display area for the number of persons of events on the display interface for playing the in-class video data.

Still referring to FIG. 3 as an example, as shown in FIG. 3, the number of students corresponding to the concentration event, the number of students corresponding to the look-around event, the number of students corresponding to the lowering-head event, the number of students corresponding to the hand-raising event, and the number of students corresponding to the stand-up event are displayed respectively through an area 3 on the display interface for playing the in-class video data. The present disclosure does not specifically limit a display sequence of the numbers of students corresponding to different in-class action events.

In a possible implementation, the method further includes: determining an in-class concentration degree based on to a ratio of the number of students corresponding to the concentration event, and the in-class concentration degree is displayed through an in-class concentration degree display area on the display interface for playing the in-class video data.

Therein, the in-class concentration degree display area may be determined according to the actual situation, for example, may be a right area that does not cover the video footage on the display interface for playing the in-class video data, which is not specifically limited in the present disclosure.

Still referring to FIG. 3 as an example, as shown in FIG. 3, the in-class concentration degree is displayed through an area 4 on the display interface for playing the in-class video data. The in-class concentration degree may be the ratio of the number of students having the concentration events at different playing moments. The in-class concentration degree may be displayed by a line chart in the present disclosure. The in-class concentration degree may also be displayed in other display forms according to the actual situation, which is not specifically limited in the present disclosure.

In a possible implementation, the method further includes: determining an in-class interaction degree based on the number of students corresponding to the hand-raising event and/or the number of students corresponding to the stand-up event; and the in-class interaction degree is displayed through an in-class interaction degree display area on the display interface for playing the in-class video data.

Therein, the in-class interaction degree display area may be determined according to the actual situation, for example, may be a right area that does not cover the video footage on the display interface for playing the in-class video data, which is not specifically limited in the present disclosure.

Still referring to FIG. 3 as an example, as shown in FIG. 3, the in-class interaction degree is displayed through an area 5 on the display interface for playing the in-class video data.

The in-class interaction degree may be the number of students having the hand-raising event and the number of students having the stand-up event within a preset duration. The in-class interaction degree may be displayed by a column diagram in the present disclosure. The in-class interaction degree may also be displayed in other display forms according to the actual situation, which is not specifically limited in the present disclosure.

In a possible implementation, the method further includes: determining an in-class delight degree based on ratios of the numbers of students corresponding to different facial expression categories, and displaying the in-class delight degree through an in-class delight degree display area on the display interface for playing the in-class video data.

Therein, the in-class delight degree display area may be determined according to the actual situation, for example, may be a right area that does not cover the video footage on the display interface for playing the in-class video data, which is not specifically limited in the present disclosure.

Still referring to FIG. 3 as an example, as shown in FIG. 3, the in-class delight degree is displayed through an area 6 on the display interface for playing the in-class video data. The in-class delight degree may be the ratios of the numbers of students corresponding to different facial expression categories at different moments. The in-class delight degree may be displayed by a line chart in the present disclosure. The in-class delight degree may also be displayed in other display forms according to the actual situation, which is not specifically limited in the present disclosure.

The mood state of the students on the teaching content at different periods of time in class may be known intuitively and effectively by displaying the in-class delight degree.

In a possible implementation, the method further includes: determining the number of attendance corresponding to the in-class video data based on the identity information of the students corresponding to different target detection boxes in the in-class video data, and displaying the number of attendance through the display interface for playing the in-class video data.

Still referring to FIG. 3 as an example, as shown in FIG. 3, the number of attendance, i.e., the actual number of students in the in-class video data is displayed through an area 7 on the display interface for playing the in-class video data. Furthermore, the number of registered students, i.e., the number of students which should actually correspond to the in-class video data may also be displayed through the area 7 on the display interface for playing the in-class video data.

In a possible implementation, the method further includes: displaying character images of the student corresponding to the target detection box through the display interface for playing the in-class video data, wherein a display sequence of the character images is related to times at which the in-class action events of the student corresponding to the target detection box occur.

Therein, the character image of the student corresponding to the target detection box may be a snapshot of the student corresponding to the target detection box, or may be a character image that is stored in the preset face database which could be used to distinguish the identities of different students, which is not specifically limited in the present disclosure.

Still referring to FIG. 3 as an example, as shown in FIG. 3, the character image corresponding to the target detection box is displayed through an area 8 on the display interface for playing the in-class video data. When the target in-class action event occurs for the student corresponding to the target detection box, the character image of the student corresponding to the target detection box is displayed in an emphasized manner, for example, the character image corresponding to the target detection box having a target in-class action event is displayed in the first place, and/or the target action event of the character image is displayed in an emphasized manner such as highlighting, flashing and the like. The target in-class action event may include the hand-raising event or the stand-up event. Moreover, the character image that needs to be displayed in the first place with priority is switched based on the occurrence time of the target in-class action event of the student corresponding to the target detection box, for example, the character image having the latest target in-class action event is switched to be displayed with priority in the first place.

In a possible implementation, the method further includes: determining duration of the student corresponding to the target detection box having the in-class action event, and the duration of the student corresponding to the target detection box having the in-class action event is displayed through the display interface for playing the in-class video data.

Still referring to FIG. 3 as an example, as shown in FIG. 3, the durations of the student corresponding to the target detection box having the concentration event, the look-around event, and the lowering-head event are displayed through an area 9 at the right side of the area 8 on the display interface for playing the in-class video data. Furthermore, the number of times of the hand-raising events and the number of times of the stand-up events of the student corresponding to the target detection box may also be displayed in the area 9.

In a possible implementation, after the learning situation analysis on the in-class video data to be analyzed is finished, a statement corresponding to the learning situation analysis result may be downloaded. The statement corresponding to the learning situation analysis result includes at least one of: the snapshot of the student, a recognition image of the student in the face recognition database, the student ID, the name of the student, a total duration of the delight facial expression, a total duration of peace facial expression, a total duration of other facial expressions, in-class staying time (a total duration when the student is consecutively recognized in class), first attendance time (the moment when the student is identified for the first time), last attendance time (the time when the student is identified for the last time), a total concentration duration, a total lowering-head duration, a total look-around duration, hand-raising times, stand-up times, etc.

Through the statement corresponding to the learning situation result, the learning situation and interaction situation of the students in class may be known more intuitively and effectively, so that the effect of the in-class teaching by the teacher may be optimized based on the learning situation analysis result. For example, for a class with fewer interactions, the teacher may be instructed to add question and answer sessions at a proper time to increase the interaction with the students, thereby improving the participation degree of the students and improving the teaching quality. Further, for example, as for the frequent occurrences of in-class action events that are unfavorable to learning, such as the look-around event and the lowering-head event, the teacher may be instructed to change the manner of teaching to increase the fun of the in-class content so as to attract the attention of the students, thereby improving the teaching quality.

It may be understood that the above method embodiments described in the present disclosure may be combined with each other to form combined embodiments without departing from principles and logics, which are not repeated in the present disclosure due to space limitation. It will be appreciated by those skilled in the art that a specific execution sequence of various steps in the above method of specific implementations are determined on the basis of their functions and possible intrinsic logics.

Furthermore, the present disclosure further provides a learning situation analysis apparatus, an electronic device, a computer-readable storage medium and a program, all of which may be used to implement any learning situation analysis method provided by the present disclosure. For the corresponding technical solutions and descriptions, please refer to the corresponding records in the method section, which will not be repeated.

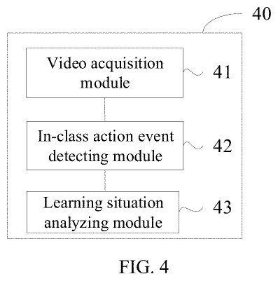

FIG. 4 illustrates a block diagram of a learning situation analysis apparatus according to an embodiment of the present disclosure. As shown in FIG. 4, an apparatus 40 includes:
a video acquisition module 41 to acquire in-class video data to be analyzed;
an in-class action event detecting module 42 to obtain an in-class action event by performing a student detection on the in-class video data, wherein the in-class action event reflects an action of a student in class; and
a learning situation analyzing module 43 to determine a learning situation analysis result corresponding to the in-class video data based on the in-class action event, wherein the learning situation analysis result reflects a learning situation of the student in class.

In a possible implementation, the apparatus 40 further includes:
a first display module to display, in response to a replay or a real-time play of the in-class video data, the learning situation analysis result through a display interface for playing the in-class video data.

In a possible implementation, the in-class action event detecting module 42 includes:
a first detection submodule to perform the student detection respectively on a plurality of frames of image included in the in-class video data to obtain at least one detection box corresponding to each frame of image in a plurality of frames of image, wherein the detection box is used to identify a detection result of the student detection in the image; and
a second detection submodule to take identical detection boxes included in the plurality of frames of image as a target detection box, and track the target detection box in the in-class video data to obtain the in-class action event of the student corresponding to the target detection box.

In a possible implementation, the student detection includes at least one of face detection or human-body detection.

In a case where the student detection includes the face detection, the student detection is performed respectively on a plurality of frames of image included in the in-class video data to obtain at least one face box corresponding to each frame of image in the plurality of frames of image.

In a case where the student detection includes the human-body detection, the student detection is performed respectively on a plurality of frames of image included in the in-class video data to obtain at least one human-body box corresponding to each frame of image in a plurality of frames of image.

In a possible implementation, the in-class action event includes at least one of a concentration event, a look-around event, a lowering-head event, a hand-raising event, or a stand-up event.

In a possible implementation, the detection box includes a face box.

The second detection submodule includes:
a first detection unit to take identical face boxes included in a plurality of frames of image as a target detection box, and track the target detection box in the in-class video data;
a second detection unit to determine that a concentration event occurs for the student corresponding to the target detection box in a case where a face angle in a horizontal direction of the face in the target detection box is detected in the tracked plurality of frames of image as being less than a first angle threshold;
and/or,
a third detection unit to determine that a look-around event occurs for the student corresponding to the target detection box in a case where the face angle in the horizontal direction of the face in the target detection box is detected in the tracked plurality of frames of image as being greater than or equal to a second angle threshold, wherein the first angle threshold is less than or equal to the second angle threshold;
and/or,
a fourth detection unit to determine that a lowering-head event occurs for the student corresponding to the target detection box in a case where the face angle in a vertical direction of the face in the target detection box is detected in the tracked plurality of frames of image as being greater than or equal to a third angle threshold.

In a possible implementation, the detection box includes a human-body box.

The second detection submodule includes:
a fifth detection unit to take identical human-body boxes included in the plurality of frames of image as a target detection box, and track the target detection box in the in-class video data;
a sixth detection unit to determine that a hand-raising event occurs for the student corresponding to the target detection box in a case where a human-body in the target detection box is detected in the tracked plurality of frames of image as having a hand-raising action;
and/or,
a seventh detection unit to determine that a stand-up event occurs for the student corresponding to the target detection box in a case where the human-body in the target detection box is detected in the tracked in-class video data as sequentially having a stand-up action, a standing action, and a sit-down action.

In a possible implementation, the seventh detection unit is specifically configured to:
determine that the stand-up event occurs for the student corresponding to the target detection box upon the following case, where a central point of the target detection box is detected in the tracked in-class video data within a target period of time greater than a duration threshold as having a horizontal offset amplitude less than a first horizontal offset threshold and a vertical offset amplitude less than a first vertical offset threshold, for a first frame of image in the target period of time, a vertical offset amplitude of the central point with respect to images before the target period of time is greater than a second vertical offset threshold, and for a last frame of image in the target period of time, a vertical offset amplitude of the central point with respect to images after the target period of time is greater than a third vertical offset threshold.

In a possible implementation, the apparatus 40 further includes:
a merging module to merge in-class action events which are the same and shave occurred multiple times consecutively in a case where a time interval between multiple consecutive occurrences of the in-class action events of the student corresponding to the target detection box is less than a first time interval threshold.

In a possible implementation, the learning situation analysis result includes at least one of:
a number of students corresponding to different in-class action events, a ratio thereof, a duration thereof, an in-class concentration degree, an in-class interaction degree, or an in-class delight degree.

In a possible implementation, the apparatus 40 further includes at least one of:
a facial expression recognition module to perform a facial expression recognition on a face image in the target detection box to obtain a facial expression category of the student corresponding to the target detection box, and display the facial expression category through an associated area of the face image on a display interface for playing the in-class video data; or
an identity recognition module to perform a face recognition on the face image in the target detection box based on a preset face database to obtain identity information of the student corresponding to the target detection box, and display the identity information through the associated area of the face image on the display interface for playing the in-class video data.

In a possible implementation, the apparatus 40 further includes:
a second display module to character images of the student corresponding to the target detection box through the display interface for playing the in-class video data, wherein a display sequence of the character images is related to times at which the in-class action event of the student corresponding to the target detection box occurs; and/or
a third display module to determine a number of attendance corresponding to the in-class video data based on the identity information of the students corresponding to different target detection boxes in the in-class video data, and display the number of student in attendance through the display interface for playing the in-class video data.

In some embodiments, functions or modules of the apparatus provided in the embodiments of the present disclosure may be used to execute the method described in the above method embodiments, which may be specifically implemented by referring to the above descriptions of the method embodiments, and are not repeated here for brevity.

An embodiment of the present disclosure further provides a computer readable storage medium having computer program instructions stored thereon, wherein the computer program instructions, when executed by a processor, implement the above method. The computer readable storage medium may be a non-volatile computer readable storage medium.

An embodiment of the present disclosure further provides an electronic device, which includes a processor and a memory configured to store processor executable instruction, wherein the processor is configured to invoke the instructions stored in the memory to execute the above method.

An embodiment of the present disclosure further provides a computer program product, which includes computer readable codes, when the computer readable codes are running on the device, the processor in the device executes the instructions for implementing the learning analysis method as provided in any of the above embodiments.

An embodiment of the present disclosure further provides another computer program product, which is configured to store computer readable instructions, when executed, ther instructions cause the computer to perform operation of the learning analysis method provided in any one of the above embodiments.

The electronic device may be provided as a terminal, a server or a device in any other form.

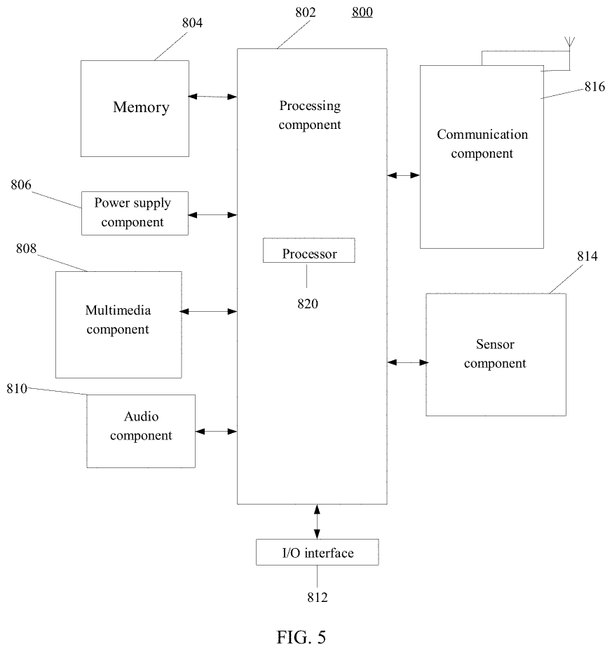

FIG. 5 illustrates a block diagram of an electronic device according to an embodiment of the present disclosure. As shown in FIG. 5, the electronic device 800 may be a mobile phone, a computer, a digital broadcast terminal, a message transceiver, a game console, a tablet device, medical equipment, fitness equipment, a personal digital assistant or any other terminal.

Referring to FIG. 5, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls the overall operation of the electronic device 800, such as operations related to display, phone call, data communication, camera operation and record operation. The processing component 802 may include one or more processors 820 to execute instructions so as to complete all or some steps of the above method. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage devices or a combination thereof, such as static random access memory (SRAM), electronic erasable programmable read-only memory (EEPROM), erasable programmable read-only memory (EPROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to the power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera. When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in the operating mode such as a call mode, a record mode and a voice identification mode, the microphone is configured to receive the external audio signal. The received audio signal may be further stored in the memory 804 or sent by the communication component 816. In some embodiments, the audio component 810 also includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to home buttons, volume buttons, start buttons and lock buttons.

The sensor component 814 includes one or more sensors which are configured to provide state evaluation in various aspects for the electronic device 800. For example, the sensor component 814 may detect an on/off state of the electronic device 800 and relative positions of the components such as a display and a small keyboard of the electronic device 800. The sensor component 814 may also detect the position change of the electronic device 800 or a component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a complementary metal oxide semiconductor (CMOS) or charge coupled device (CCD) image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wire or wireless manner between the electronic device 800 and other devices. The electronic device 800 may access a wireless network based on communication standards, such as wireless fidelity (WiFi), second generation mobile telecommunication (2G) or third generation mobile telecommunication (3G), or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to promote the short range communication. For example, the NFC module may be implemented on the basis of radio frequency identification (RFID) technology, infrared data association (IrDA) technology, ultrawide band (UWB) technology, Bluetooth (BT) technology and other technologies.

In exemplary embodiments, the electronic device 800 may be implemented by one or more application dedicated integrated circuits (ASIC), digital signal processors (DSP), digital signal processing device (DSPD), programmable logic device (PLD), field programmable gate array (FPGA), controllers, microcontrollers, microprocessors or other electronic elements and is used to execute the above method.

In an exemplary embodiment, there is further provided a non-volatile computer readable storage medium, such as a memory 804 including computer program instructions. The computer program instructions may be executed by a processor 820 of an electronic device 800 to implement the above method.

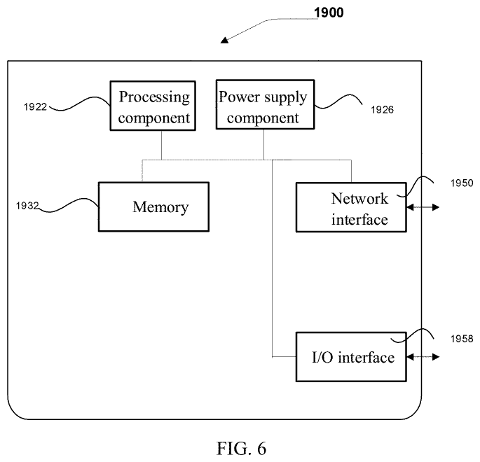

FIG. 6 illustrates a block diagram of an electronic device according to an embodiment of the present disclosure. As shown in FIG. 6, the electronic device 1900 may be provided as a server. Referring to FIG. 6, the electronic device 1900 includes a processing component 1922, and further includes one or more processors and memory resources represented by a memory 1932 and configured to store instructions executed by the processing component 1922, such as an application program. The application program stored in the memory 1932 may include one or more modules each corresponding to a group of instructions. Furthermore, the processing component 1922 is configured to execute the instructions so as to execute the above method.

The electronic device 1900 may further include a power supply component 1926 configured to perform power supply management on the electronic device 1900, a wire or wireless network interface 1950 configured to connect the electronic device 1900 to a network, and an input/output (I/O) interface 1958. The electronic device 1900 may run an operating system stored in the memory 1932, such as windows server operating systems (Windows Server™), graphical user interface operating systems (Mac OS X™) introduced by Apple, a multi-user and multi-process computer operating systems (Unix™), Unix-like operating systems with free and open source codes (Linux™), open source Unix-like operating systems (FreeBSD™) or the like.

In an exemplary embodiment, there is further provided a non-volatile computer readable storage medium, such as a memory 1932 including computer program instructions. The computer program instructions may be executed by a processing module 1922 of an electronic device 1900 to execute the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium may be a tangible device that may retain and store instructions used by an instruction executing device. The computer readable storage medium may be a volatile storage medium or a non-volatile storage medium. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein may be downloaded to individual computing/processing devices from a computer readable storage medium or to an external computer or external storage device via network, for example, the Internet, local region network, wide region network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operation of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local region network (LAN) or wide region network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, may be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, may be implemented by dedicated hardware-based systems performing the specified functions or acts, or by combinations of dedicated hardware and computer instructions.

The computer program product may be implemented specifically by hardware, software or a combination thereof. In an optional embodiment, the computer program product is specifically embodied as a computer storage medium. In another optional embodiment, the computer program product is specifically embodied as a software product, such as software development kit (SDK) and the like.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. A learning situation analysis method, comprising:
acquiring in-class video data to be analyzed;
obtaining an in-class action event by performing a student detection on the in-class video data, wherein the in-class action event reflects an action of a student in class; and
determining a learning situation analysis result corresponding to the in-class video data based on the in-class action event, wherein the learning situation analysis result reflects a learning situation of the student in class.

2. The method according to claim 1, further comprising:
in response to a replay or a real-time play of the in-class video data, displaying the learning situation analysis result through a display interface for playing the in-class video data.

3. The method according to claim 1, wherein the in-class video data comprises a plurality of frames of image, and obtaining the in-class action event by performing the student detection on the in-class video data comprises:
performing the student detection respectively on the plurality of frames of image to obtain at least one detection box corresponding to each frame of image in the plurality of frames of image, wherein the detection box identifies a detection result of the student detection in the image;
taking identical detection boxes included in the plurality of frames of image as a target detection box, and tracking the target detection box in the in-class video data to obtain the in-class action event of a student corresponding to the target detection box.

4. The method according to claim 3, wherein the detection box comprises a face box;
taking the identical detection boxes included in the plurality of frames of image as the target detection box, and tracking the target detection box in the in-class video data to obtain the in-class action event of the student corresponding to the target detection box comprises:
taking identical face boxes included in the plurality of frames of image as the target detection box, and tracking the target detection box in the in-class video data;
in response to detecting that a face angle in a horizontal direction of a face in the target detection box is less than a first angle threshold, determining that a concentration event occurs for the student corresponding to the target detection box.

5. The method according to claim 4, wherein taking the identical detection boxes included in the plurality of frames of image as the target detection box, and tracking the target detection box in the in-class video data to obtain the in-class action event of a student corresponding to the target detection box comprises:
in response to detecting that a second face angle in the horizontal direction of the face in the target detection box is greater than or equal to a second angle threshold, determining that a look-around event occurs for the student corresponding to the target detection box, wherein the first angle threshold is less than or equal to the second angle threshold.

6. The method according to claim 3, wherein the detection box comprises a face box;
taking the identical detection boxes included in the plurality of frames of image as the target detection box, and tracking the target detection box in the in-class video data to obtain the in-class action event of the student corresponding to the target detection box comprises:
taking identical face boxes included in the plurality of frames of image as the target detection box, and tracking the target detection box in the in-class video data;
in response to detecting that a face angle in a vertical direction of a face in the target detection box is greater than or equal to a third angle threshold, determining that a lowering-head event occurs for the student corresponding to the target detection box.

7. The method according to claim 3, wherein:
the detection box comprises a human-body box; and
taking the identical detection boxes included in the plurality of frames of image as the target detection box, and tracking the target detection box in the in-class video data to obtain the in-class action event of the student corresponding to the target detection box comprises:
taking identical human-body boxes included in the plurality of frames of image as the target detection box, and tracking the target detection box in the in-class video data;
in response to detecting that a human-body in the target detection box has a hand-raising action, determining that a hand-raising event occurs for the student corresponding to the target detection box.

8. The method according to claim 3, wherein the detection box comprises a human-body box;
taking the identical detection boxes included in the plurality of frames of image as the target detection box, and tracking the target detection box in the in-class video data to obtain the in-class action event of the student corresponding to the target detection box comprises:
taking identical human-body boxes included in the plurality of frames of image as the target detection box, and tracking the target detection box in the in-class video data; and
in response to detecting that a human-body in the target detection box has a stand-up action, a standing action, and a sit-down action sequentially, determining that a stand-up event occurs for the student corresponding to the target detection box.

9. The method according to claim 8, wherein determining that the stand-up event occurs for the student corresponding to the target detection box in response to detecting that the human-body in the target detection box has the stand-up action, the standing action, and the sit-down action sequentially comprises:
determining that the stand-up event occurs for the student corresponding to the target detection box upon the following condition:
within a target period of time of the in-class video data greater than a duration threshold, a central point of the target detection box is detected as having a horizontal offset amplitude less than a first horizontal offset threshold and a vertical offset amplitude less than a first vertical offset threshold,
for a first frame of image in the target period of time, a vertical offset amplitude of the central point with respect to images before the target period of time is greater than a second vertical offset threshold, and
for a last frame of image in the target period of time, a vertical offset amplitude of the central point with respect to images after the target period of time is greater than a third vertical offset threshold.

10. The method according to claim 3, further comprising:
merging in-class action events which are the same and have occurred multiple times consecutively in response to that a time interval between multiple consecutive occurrences of the in-class action events of the student corresponding to the target detection box is less than a first time interval threshold.

11. The method according to claim 1, wherein the learning situation analysis result comprises at least one of:
a number of students corresponding to different in-class action events, a ratio of the number of students corresponding to different in-class action events to a total number of students, a duration of the different in-class action events, an in-class concentration degree, an in-class interaction degree, or an in-class delight degree.

12. The method according to claim 3, further comprising at least one of:
performing a facial expression recognition on a face image in the target detection box to obtain a facial expression category of the student corresponding to the target detection box, and displaying the facial expression category through an associated area of the face image on a display interface for playing the in-class video data; or
performing a face recognition on the face image in the target detection box based on a preset face database to obtain identity information of the student corresponding to the target detection box, and displaying the identity information through the associated area of the face image on the display interface for playing the in-class video data.

13. The method according to claim 3, further comprising:
displaying character images of the student corresponding to the target detection box through a display interface for playing the in-class video data, wherein a display sequence of the character images is related to times at which in-class action events of the student corresponding to the target detection box occur.

14. The method according to claim 3, further comprising:
determining a number of attendance corresponding to the in-class video data based on identity information of students corresponding to different target detection boxes in the in-class video data; and
displaying the number of attendance through a display interface for playing the in-class video data.

15. An electronic device, comprising:
at least one processor; and
at least one memory configured to store processor executable instructions,
wherein when executed by the at least one processor the instructions cause the at least one processor to:
acquire in-class video data to be analyzed;
obtain an in-class action event by performing a student detection on the in-class video data, wherein the in-class action event reflects an action of a student in class; and
determine a learning situation analysis result corresponding to the in-class video data based on the in-class action event, wherein the learning situation analysis result reflects a learning situation of the student in class.

16. The electronic device according to claim 15, wherein the instructions further cause the at least one processor to:
in response to a replay or a real-time play of the in-class video data, display the learning situation analysis result through a display interface for playing the in-class video data.

17. The electronic device according to claim 15, wherein the in-class video data comprises a plurality of frames of image, and the instructions further cause the at least one processor to:
perform the student detection respectively on the plurality of frames of image to obtain at least one detection box corresponding to each frame of image in the plurality of frames of image, wherein the detection box identifies a detection result of the student detection in the image; and
take identical detection boxes included in the plurality of frames of image as a target detection box, and track the target detection box in the in-class video data to obtain the in-class action event of a student corresponding to the target detection box.

18. The electronic device according to claim 17, wherein the detection box comprises a face box, and
the instructions further cause the at least one processor to:
take identical face boxes included in the plurality of frames of image as the target detection box, and track the target detection box in the in-class video data;
in response to detecting that a face angle in a horizontal direction of a face in the target detection box is less than a first angle threshold, determine that a concentration event occurs for the student corresponding to the target detection box; or
in response to detecting that a second face angle in the horizontal direction of the face in the target detection box is greater than or equal to a second angle threshold, determine that a look-around event occurs for the student corresponding to the target detection box, wherein the first angle threshold is less than or equal to the second angle threshold; or
in response to detecting that a third face angle in a vertical direction of the face in the target detection box is greater than or equal to a third angle threshold, determine that a lowering-head event occurs for the student corresponding to the target detection box.

19. The electronic device according to claim 15, wherein the learning situation analysis result comprises at least one of:
a number of students corresponding to different in-class action events, a ratio of the number of students corresponding to different in-class action events to a total number of students, a duration of the different in-class action events, an in-class concentration degree, an in-class interaction degree, or an in-class delight degree.

20. A non-transitory computer readable storage medium having computer program instructions stored thereon, wherein when executed by at least one processor the instructions cause the at least one processor to:
acquire in-class video data to be analyzed;
obtain an in-class action event by performing a student detection on the in-class video data, wherein the in-class action event reflects an action of a student in class; and
determine a learning situation analysis result corresponding to the in-class video data based on the in-class action event, wherein the learning situation analysis result reflects a learning situation of the student in class.
